(19) United States
(12) Patent Application Publication
(10) Pub. No.: US 2011/0174788 A1
(43) Pub. Date: Jul. 21, 2011

(54) LASER ENGRAVER WITH SCANNING FUNCTION

(75) Inventor: Chi Ming William Chai, Hsi Chih City (TW)

(73) Assignee: GREAT COMPUTER CORPORATION, Hsi Chih City (TW)

(21) Appl. No.: 12/691,182

(22) Filed: Jan. 21, 2010

(51) Int. Cl. B23K 26/38

(52) U.S. Cl. 219/121.68

(57) ABSTRACT

A laser engraver with scanning function includes an engraving table, a control device, and a scanner. The engraving table includes a working platform and an engraving device disposed on the working platform. The engraving device is capable of moving above the working platform to perform an engraving operation. The control device is connected to the engraving device, and is used for controlling the engraving operation of the engraving device. The scanner is mounted on the engraving device and connected to the control device, and is used for scanning a workpiece placed on the working platform and transmitting scanned information to the control device, such that the control device controls the engraving device to perform an accurate engraving operation at a particular position on the workpiece.

### BACKGROUND OF THE INVENTION

1. Field of Invention

The present invention relates to a laser engraver with scanning function, which uses a scanner to scan a workpiece in advance before performing an engraving operation, so as to facilitate the subsequent engraving operation.

2. Related Art

A laser engraving process is quite simple, like printing on paper using a computer and a printer. After various patterns are edited, the patterns are “printed” to an engraver by a computer. The only difference is that, printing is to apply ink to paper, while laser engraving is to output a laser to a workpiece such as wood, acrylic, plastic board, metal board, or stone board, so as to complete the engraving process.

Currently, according to the structural design of the laser engraver, the engraving operation is mainly performed using a pen carriage. Before performing the engraving operation, a user needs to measure the workpiece first, for example, measure the size of the workpiece or a working area to be engraved, and then input the measured values into a computer of the laser engraver. The computer organizes the values, and provides the values to the pen carriage, so as to perform the subsequent engraving operation. However, the manual measurement process is complicated and time-consuming, and the desired accuracy cannot be achieved.

### SUMMARY OF THE INVENTION

Accordingly, the present invention is mainly directed to a laser engraver with scanning function, which has a simple structure, and can reduce the working time and improve the engraving efficiency.

In order to achieve the above objectives, the present invention provides a laser engraver with scanning function, which includes an engraving table, a control device, and a scanner. The engraving table includes a working platform and an engraving device disposed on the working platform. The engraving device is capable of moving above the working platform to perform an engraving operation. The control device is connected to the engraving device, and is used for controlling the engraving operation of the engraving device. The scanner is mounted on the engraving device and connected to the control device, and is used for scanning a workpiece placed on the working platform and transmitting scanned information to the control device, such that the control device controls the engraving device to perform an accurate engraving operation at a particular position on the workpiece.

In the implementation, the engraving device includes a working track and a pen carriage, and the pen carriage is movably mounted on the working track, such that the pen carriage is capable of performing an engraving operation on the working track.

In the implementation, the scanner is mounted on the working track or the pen carriage.

In the implementation, the control device is a computer.

In order to make the present invention more comprehensible, features and effects of the present invention are described in detail below through preferred embodiments with reference to the drawings and drawing numbers.

### BRIEF DESCRIPTION OF THE DRAWINGS

The present invention will become more fully understood from the detailed description given herein below for illustration only, and thus are not limitative of the present invention, and wherein:

FIG. 1 is a state diagram showing that a scanner is mounted on a pen carriage according to an embodiment of the present invention; and

FIG. 2 is a state diagram showing that a scanner is mounted on a working track according to an embodiment of the present invention.

### DETAILED DESCRIPTION OF THE INVENTION

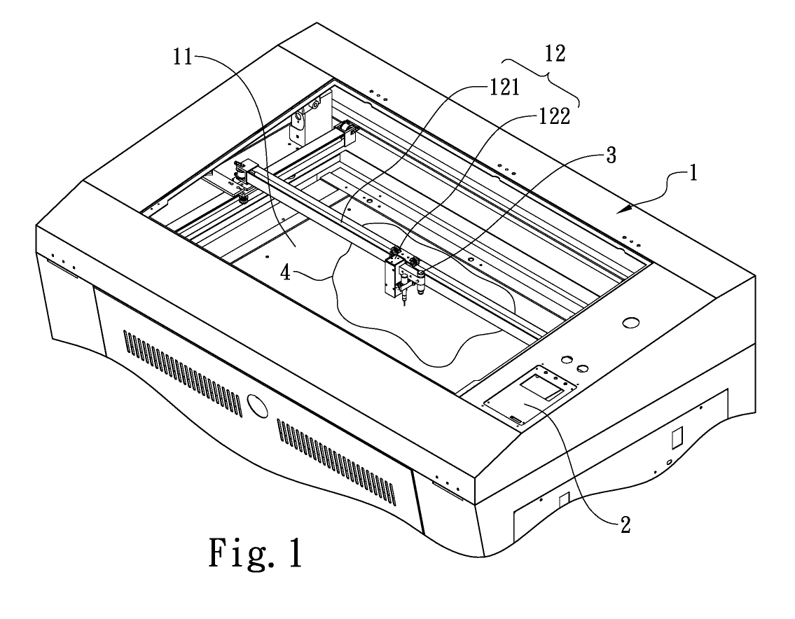

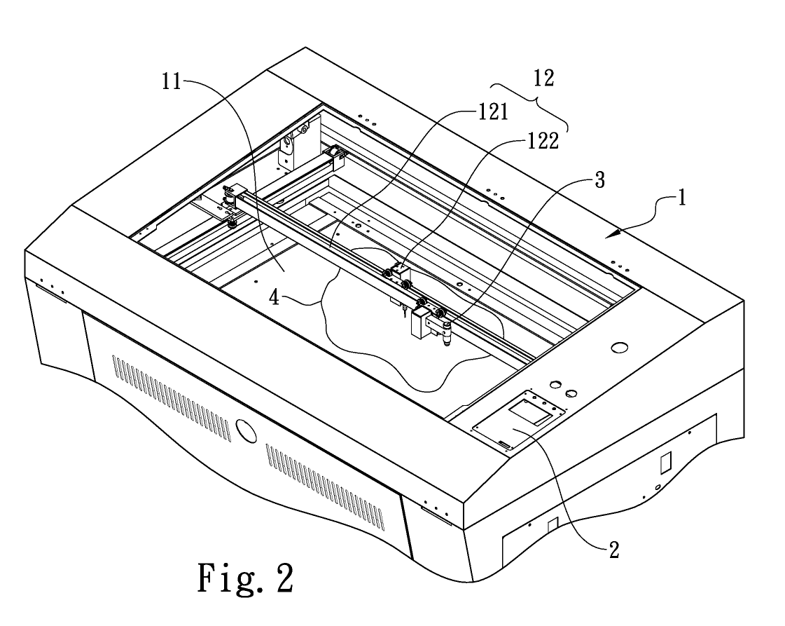

Referring to FIGS. 1 and 2, a laser engraver with scanning function of the present invention includes an engraving table 1, a control device 2, and a scanner 3.

The engraving table 1 includes a working platform 11 and an engraving device 12 disposed on the working platform 11. The engraving device 12 includes a working track 121 and a pen carriage 122. The pen carriage 122 is movably mounted on the working track 121, such that the pen carriage 122 is capable of performing an engraving operation on the working track 121. The control device 2 is a computer, which is connected to the engraving device 12, and is used for controlling the engraving operation of the engraving device 12. The scanner 3 is mounted on the pen carriage 122 (as shown in FIG. 1) or the working track 121 (as shown in FIG. 2) of the engraving device 12 and connected to the control device 2, and is used for scanning a workpiece 4 placed on the working platform 11 and transmitting scanned information to the control device 2, such that the control device 2 controls the engraving device 12 to perform an accurate engraving operation at a particular position on the workpiece 4.

Therefore, in the implementation, referring to FIG. 1, after the workpiece 4 is placed on the working platform 11, a user uses the control device 2 to control the scanner 3, so as to enable the scanner 3 to move back and forth on the working track 121 to scan the workpiece 4 placed on the working platform 11, for example, scan the size of the workpiece 4 or a working area to be engraved. The scanner 3 then transmits scanned information to the control device 2, such that the control device 2 controls the pen carriage 122 on the working track 121 to directly perform an engraving operation.

Therefore, with the design of the present invention, when performing an engraving operation, the user can sequentially perform the scanning measurement and engraving operation by placing the workpiece 4 on the working platform 11, without otherwise measuring the workpiece 4, thereby effectively reducing the working time and improving the engraving accuracy.

While the present invention has been described with reference to the embodiments and technical means thereof, various changes and modifications can be made based on the disclosure or teachings described herein. Any equivalent changes made based on the concepts of the present invention having their effect without departing from the spirit encompassed by the specification and drawings should be construed as falling within the scope of the invention as defined by the appended claims.

According to the aforementioned disclosure, the present invention surely can achieve the expected objectives to provide a laser engraver with scanning function, which has industrial applicability. Thus, the application for a patent is filed according to the law.

What is claimed is:

1. A laser engraver with scanning function, comprising:
an engraving table, comprising a working platform and an engraving device disposed on the working platform, wherein the engraving device is capable of moving above the working platform to perform an engraving operation;
a control device, connected to the engraving device, for controlling the engraving operation of the engraving device; and
a scanner, mounted on the engraving device and connected to the control device, for scanning a workpiece placed on the working platform and transmitting scanned information to the control device, such that the control device controls the engraving device to perform an accurate engraving operation at a particular position on the workpiece.

2. The laser engraver with scanning function according to claim 1, wherein the engraving device comprises a working track and a pen carriage, and the pen carriage is movably mounted on the working track, such that the pen carriage is capable of performing an engraving operation on the working track.

3. The laser engraver with scanning function according to claim 2, wherein the scanner is mounted on the working track.

4. The laser engraver with scanning function according to claim 2, wherein the scanner is mounted on the pen carriage.

5. The laser engraver with scanning function according to claim 1, wherein the control device is a computer.
